(19) United States
(12) Patent Application Publication
(10) Pub. No.: US 2026/0244425 A1
(43) Pub. Date: Aug. 20, 2026

(54) METHOD AND SYSTEM FOR CHECKING MODIFICATIONS TO BE CARRIED OUT ON THE SYSTEM RUNTIME ENVIRONMENT DURING THE INSTALLATION PROCESS

(71) Applicant: SIEMENS AKTIENGESELLSCHAFT, München (DE)

(72) Inventors: Christian Peter FEIST, Grafrath (DE); Stefan PYKA, Markt Schwaben (DE); Thomas ZESCHG, München (DE); Rainer FALK, Erding (DE); Peter HORNUNG, Erlangen (DE); Martin MANTEL, Schmalkalden OT Wernshausen (DE); Franz SPERL, Oberviechtach (DE)

(21) Appl. No.: 19/157,476

(22) PCT Filed: Jan. 26, 2024
(86) PCT No.: PCT/EP2024/051957

§ 371 Date: Aug. 18, 2025

(30) Foreign Application Priority Data
Feb. 21, 2023 (EP) 23157748.7

(51) Int. Cl. G06F 8/61; G06F 21/51; G06F 21/53; G06F 21/57

(52) U.S. Cl. CPC G06F 8/61; G06F 21/51; G06F 21/53; G06F 21/57

(57) ABSTRACT

A computer-implemented method for carrying out an installation process for an application on a runtime environment during the operation of a system, while checking modifications to be carried out on the runtime environment during the installation process, including: configuring at least one installation protection profile for the runtime environment depending on an installation guideline provided for controlling the installation process, b) carrying out an installation process of an installation package of the application to be installed for checking purposes on a test runtime environment isolated from the runtime environment using the at least one installation protection profile; c) checking whether the installation process is carried out in accordance with the installation protection profile; d) carrying out the installation process of the installation package to be installed on the runtime environment, if the result of the check is positive; and, e) otherwise, rejecting or aborting the installation process.

### CROSS REFERENCE TO RELATED APPLICATIONS

This application is a national stage of PCT Application No. PCT/EP2024/051957, having a filing date of Jan. 26, 2024, which claims priority to EP Application No. 23157748.7, having a filing date of Feb. 21, 2023, the entire contents both of which are hereby incorporated by reference.

### FIELD OF TECHNOLOGY

The following relates to a method and system for performing an installation process for an application on a runtime environment during operation of a system, with checking of modifications, to be performed during the installation process, on the system runtime environment, and to an associated computer program product.

### BACKGROUND

Since industrial systems (controllers, industrial PCs, IoT and edge devices, cloud servers) are often used in the field over a long period, they are subject to constantly changing requirements and a dynamic environment. To deal with these circumstances, new devices are developed primarily such that they are able to be adapted flexibly over their usage time, for example by being supported by downloadable applications or apps. An application is downloaded primarily during operation or at runtime of a system or device.

By way of example, in industrial edge, which is described for example in https://new.siemens.com/de/de/produkte/automatisierung/themenfelder/industrial-edge.html, there is the possibility of various manufacturers being able to provide different apps, for example in an app store, which are able to be installed on the device by the operator of the device. As a result of an offering that is as broad as possible, applications from different manufacturers may potentially adopt different formats (for example docker containers, Debian packages, simple tar archive) and require different levels of integration with embodiments of the system (for example few rights, very invasive rights). This places stronger demands on the security mechanisms of such a device. Secure operation in particular requires a controlled installation process for an application. An application developer in this case determines, with a certain degree of freedom, which parts of a device runtime environment are modified in the course of the installation process. This degree of freedom may be different, primarily depending on the app format. By way of example, Debian packages may contain installation scripts that are provided by the app developer and are executed on embodiments of the system with the highest rights.

It is possible to restrict privileges of one or more software components on the system level (see for example https://www.linux.com/learn/overview-linux-kernel-security-features). Under the Linux operating system, for example mandatory access control (MAC, for example SELinux or AppArmor), system call filtering (seccomp), Linux capabilities or virtualization mechanisms (namespaces) are known here. In MAC, rights of applications are defined for example by way of access rules in a policy, which is then implemented by the operating system kernel. If an application carries out an operation for which it does not have permission, this operation may be prevented or reported. This serves as protection against an attacker having control over one or more applications. These mechanisms may in particular also be used to restrict the rights of a root user.

Package managers such as dpkg make it possible to recognize whether the installation of an application package leads to files belonging to another application package being overwritten (see for example https://askubuntu.com/questions/176121/dpkg-error-trying-to-overwrite-file-which-is-also-in). In Linux, an auditing mechanism, for example auditd (https://linux.die.net/man/8/auditd), may be used to recognize and report access events (for example write access to a file by an application). These access events are then stored in a log file, for example /var/log/audit/audit.log. Under the Windows operating system, an audit policy may be configured in order for example to log changes to specific files (see https://blog.netwrix.com/2018/08/23/auditing-windows-server/). These events are then stored, under specific identifiers, in the Windows Event log system, which is able to be viewed and evaluated.

### SUMMARY

An aspect relates to a method and a system so as to develop a method, respectively system, each improved compared to the prior art, for performing an installation process for at least one (downloadable) application in a runtime environment, wherein monitoring of modifications to be performed during the installation process is intended to be ensured.

The invention claims a (computer-implemented) method for performing an installation process for an application on a runtime environment during operation of a system, with checking or monitoring of modifications, to be performed during the installation process, on embodiments of the system runtime environment, comprising the following steps:
a) configuring and/or selecting a configuration of at least one installation protection profile for the runtime environment on the basis of an installation policy provided for the purpose of monitoring the installation process,
b) performing an installation process for an installation package, to be installed, of the application, for checking purposes, on a test runtime environment isolated from the runtime environment, with application of the at least one installation protection profile, which defines permitted and/or forbidden modifications on the runtime environment during the installation process,
c) checking whether the installation process has been performed with the installation protection profile being complied with,
d) performing the installation process for the installation package, to be installed, on the runtime environment when the check result is judged to be positive,
e) otherwise rejecting or aborting the installation process.

According to the invention, what is described is an app installation mechanism that is executed, for test purposes, in a protected or monitored runtime environment in order to prevent unwanted modifications to embodiments of the system by the installation. The installation of downloadable applications is thus enabled in a way that is able to ensure the integrity of the rest of embodiments of the system.

For this purpose, an installation process on a test runtime environment isolated from embodiments of the system runtime environment is checked as to whether a previously configurable installation protection profile has been complied with and not violated. By way of example, violation of the installation protection profile may be brought about when operations that are not permitted in accordance with the installation protection profile are performed on a file system, for example.

In the event of a positive check, the installation process may be completed. In the event of a negative check, the installation process is rejected or aborted, that is to say is not completed.

At least one installation protection profile (AIIP) is configured with the aid of metadata contained in the installation package and/or with the aid of states and/or rights of the runtime environment and/or of embodiments of the system.

The test runtime environment may be provided on embodiments of the system itself in isolation from embodiments of the system runtime environment or be provided separately on another system. In order to monitor the installation process, it is possible to use an installation control unit that is configured or able to be configured with the one or more installation protection profiles.

A log may also be supplied as an accompaniment to the check result or as the check result, the log having logged the modifications performed during the installation process. It is then possible to derive a positive or negative check result therefrom.

The check result may be attested cryptographically.

In embodiments, the method is computer-aided or computer-implemented or is performed in computer-aided or computer-implemented fashion. The steps of embodiments of the method may be repeated as often as desired, and repetitions may possibly be ended based on defined conditions, be these event-oriented or time-limited.

A further aspect of the invention is a system suitable for performing an installation process for an application (app) on a system runtime environment during operation of a system, with checking of modifications, to be performed during the installation process, on embodiments of the system runtime environment, wherein embodiments of the system is designed to perform abovementioned steps a) to e).

Use may also be made of a computer program product (non-transitory computer readable storage medium having instructions, which when executed by a processor, perform actions) comprising a non-volatile storage medium storing a loadable and executable program code that executes embodiments of the method according to one of the abovementioned embodiments in a processor unit in particular of one or, in distributed fashion, in multiple devices according to one of the embodiments described above.

Also claimed is a variant of the computer program product comprising program commands for configuring a creation device, for example a 3D printer, a computer system or a manufacturing machine suitable for creating processors and/or devices, wherein the creation device is configured by way of the programming commands such that the execution environment is able to be created.

In embodiments, the system and devices, units and computer program (products), which may comprise a loadable and executable program code or program code modules able to be loaded and executed in distributed fashion, may be designed in accordance with the developments/embodiments of the abovementioned method and the developments/embodiments thereof, and vice versa.

One embodiment of the invention makes provision for one or more units or components or devices to be able to be integrated into embodiments of the system and for these to be able to be in the form of a software, firmware or hardware component. In embodiments, system generally comprises at least one processor that is able to execute operations on the operating system level as an operating system kernel.

A processor or processor unit may in particular be a central processing unit (CPU), a microprocessor or a microcontroller, for example an application-specific integrated circuit or a digital signal processor, possibly in combination with a storage unit for storing program commands, etc. A processor may also for example be an integrated circuit (IC) or a multi-chip module, in particular a field-programmable gate array (FPGA) or an application-specific integrated circuit (ASIC), a system-on-chip (SoC), a graphics processing unit (GPU), a processor for evaluating a neural network, such as for example a tensor processing unit (TPU) or a digital signal processor (DSP). The processor may have one or more computing cores (multicore). A processor may also be understood to be a virtualized processor or a soft CPU. It may also, for example, be a programmable processor that is furnished with configuration steps for executing the method according to the invention or is configured by way of configuration steps such that the programmable processor implements the features according to embodiments of the invention of the method or other aspects and sub-aspects of the invention. The processor may have tamper-proofing for protection against physical manipulations, for example tamper sensors for detecting physical attacks.

### BRIEF DESCRIPTION

Some of the embodiments will be described in detail, with references to the following Figures, wherein like designations denote like members, wherein:

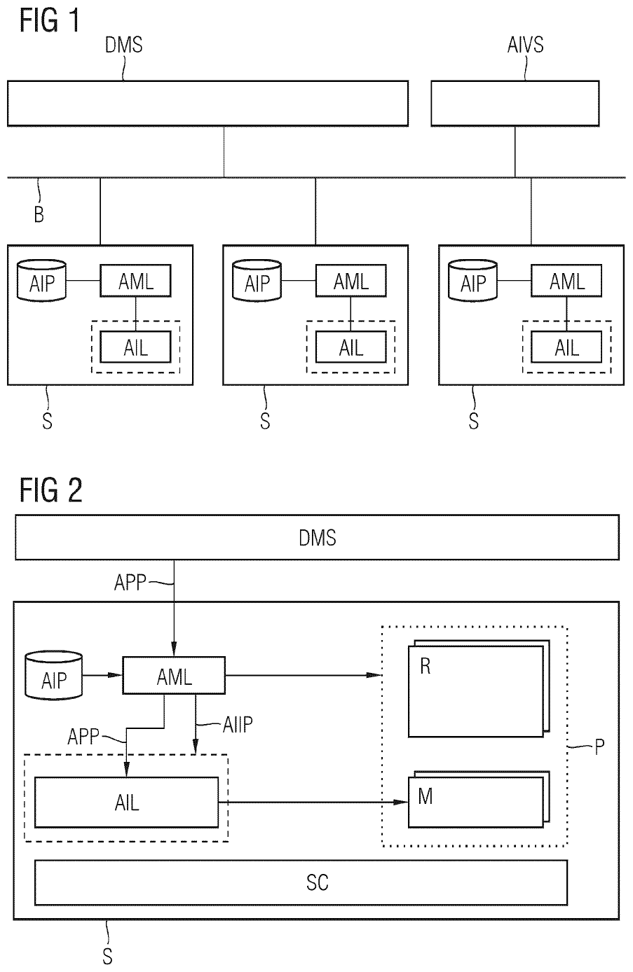

FIG. 1 shows an exemplary arrangement in the context of which embodiments of the method may be applied; and

FIG. 2 shows a design of a system suitable for performing embodiments of the method.

### DETAILED DESCRIPTION

FIG. 1 shows the use of the invention on a system S, which is for example an automation component, and which permits the dynamic addition or downloading of applications (apps) during operation.

Multiple such systems may be connected to one another in a network of an industrial installation via a bus system/network B.

FIG. 2 shows embodiments of the system S in an embodiment that is more detailed than FIG. 1. An app management logic AML on embodiments of the system S receives an app package APP for example from an app management system DMS or via a USB stick plugged into embodiments of the system. The app management logic is configured, by way of an (app) installation policy AIP, to determine a corresponding installation protection profile AIIP for an app installation logic AIL in an installation control unit (illustrated in dashed form in FIG. 2). When configuring the installation protection profile or selecting potentially present (preconfigured) configurations, a wide variety of factors may be taken into consideration, such as for example
metadata, which may comprise the signature/manufacturer of the app, or origin of the app package (for example the server from which it was loaded)
a manifest of the app package, specifying the changes or modifications (for example paths accessed), performed by the installation, on embodiments of the system
contents of the installation scripts of the app package
rights of the runtime environment required by the app on embodiments of the system,
current system state (for example setup or maintenance mode) and
information from or about components that are already installed

Generally speaking, an application package or app package APP is received, for the purpose of installing the application on embodiments of the system S, for example from an app server, here the app management system DML, and is intended to be installed on the runtime environment P of embodiments of the system (illustrated in dotted form in FIG. 2) or, for test purposes, on the test runtime environment.

The app package is checked for the purpose of configuring or selecting a suitable device-specific installation protection profile AIIP. The installation protection profile AIIP is applied by:
Starting an app installation process, marked R in FIG. 2, with the aid of an app installation policy on embodiments of the system in a restricted test runtime environment. In this variant, the test system is implemented on the actual system itself.
Or the app package is transmitted to a test runtime environment on a separate, different system, marked AIVS in FIG. 1, on which the installation process is executed in a restricted test runtime environment.

In the event of successful performance of the installation process with the installation protection profile being complied with, the modifications triggered by the installation process are adopted or the modifications are applied to embodiments of the system, marked M in FIG. 2.

In the event of unsuccessful installation in accordance with the installation protection profile, the installation process is ended or aborted. This may be followed by outputting of an error message, etc.

The configured or selected installation protection profile AIIP may, in FIG. 2, for example be a special SELinux or AppArmor profile, a sandbox environment configured by way of Linux namespaces and bind mounts, or an additional component for monitoring file system access operations/the integrity of specific files. The app installation logic AIL is then executed for the purpose of installing the application package (for example a Debian package app-package. deb) with application of the installation protection profile AIIP, for example by executing the command dpkg -i app-package. deb under the selected AppArmor or SELinux profile. All of the installation scripts of the app package are thereby also executed with rights that are restricted on a targeted basis. The AppArmor or SELinux profile may for example be defined such that access operations to specific core parts SC of embodiments of the system (system core artefacts), such as for example /dev/mem or the Linux kernel image, are prohibited. If operations that are not permitted by the installation protection profile are recognized, the installation process may be aborted.

Provision may also be made for different app installation logics AIL that are selected to perform the installation based on the installation protection profile AIIP. By way of example, provision may be made for two differently configured/compiled versions of the package manager dpkg that differ in terms of the file system paths that they modify (corresponds to a policy hard-coded in the app installation logic AIL).

The corresponding installation protection profiles AIIP may be preconfigured or be generated at runtime, for example on the basis of an app manifest that specifies which paths need to be modified for an installation. The app installation policy AIP and the installation protection profiles AIIP depending thereon may in particular be device-specific or system-specific, such that it is possible to address the protection objectives relevant for the respective intended use of a system.

If the application or app package is checked on a separate server, AIVS in the example, then the app installation policy AIP specifies for example that the installation of app packages from unknown manufacturers first has to be tested on a server AIVS. For this purpose, the app management logic AML transmits the app package, along with the installation protection profile to be complied with by an installation (for example certain paths that are not permitted to be modified), to the server AIVS. The latter installs the app package in its test runtime environment, which is representative of embodiments of the system S (for example the same Linux distribution/basis image, digital twin). It is checked whether the app was able to be installed with the transmitted installation protection profile being complied with. If, for example, unwanted modifications are identified during the installation, this is judged to be a violation of the installation protection profile. The check result is reported back to the app management logic AML. This may decide, based thereon, to install the app on embodiments of the system or to potentially abort the installation process.

It is possible for the server AIVS to attach a cryptographic attestation of the runtime environment to the test result. The app management logic AML may thus assume, with a high probability, that the installation took place in an expected, restricted test runtime environment. As an alternative, attestation may be performed by the server AIVS even before the app package is transmitted.

As already mentioned above, a test installation of the app package may also be performed on a protected, synthetic test runtime environment on embodiments of the system itself (for example in a dedicated virtual machine, Linux container, special tmpfs/Overlayfs structure), or for example the app/device management system.

The server AIVS or embodiments of the system-internal test runtime environment might also output not a check result, but rather a log of the changes or modifications to the runtime environment, for example by comparing the states before and after the installation, recording file access operations, etc. The app management logic may then assess the log and decide whether the app package should be installed on embodiments of the system.

The restrictions of the installation protection profile may also be transferred to the runtime rights of apps. If for example the installation protection profile specifies that files under/boot are not permitted to be changed as part of the installation, this restriction may be carried over to a system-internal test runtime environment, for example corresponding runtime isolation profile (for example SELinux, AppArmor) of the app.

Although the invention has been described and illustrated in more detail by the exemplary embodiment, the invention is not restricted by the disclosed examples, and other variations may be derived therefrom by a person skilled in the art without departing from the scope of protection of the invention.

The processes or method sequences described above may be implemented based on instructions present on computer-readable storage media or in volatile computer memories (referred to collectively below as computer-readable memories). Computer-readable memories are for example volatile memories such as caches, buffers or RAMs and non-volatile memories such as interchangeable data media, hard drives, etc.

The functions or steps described above may in this case be present in the form of at least one set of instructions in/on a computer-readable memory. The functions or steps are in this case not bound to a specific set of instructions or to a specific form of sets of instructions or to a specific storage medium or to a specific processor or to specific execution schemes and may be executed by software, firmware, microcode, hardware, processors, integrated circuits etc. operating on their own or in any combination. A wide variety of processing strategies may be used here, for example serial processing by a single processor or multiprocessing or multitasking or parallel processing, etc.

The instructions may be stored in local memories, but it is also possible to store the instructions on a remote system and to access this via a network.

The term “computer-aided” or “computer-implemented” may, in connection with the invention, be understood for example to mean an implementation of embodiments of the method in which in particular a processor, which may be part of a (control/computing) device or unit, executes at least one method step of the method. In embodiments, the method may in this case also be implemented in a computer cloud that is able to execute embodiments of the method and is thus able to deliver results of embodiments of the method to a control/computing device or unit, which is able to direct appropriate commands or measures to the devices, in particular those of the abovementioned arrangement.

Unless indicated otherwise in the following description, the terms “map”, “emulate”, “receive”, “apply”, “output”, “provide” and the like refer to actions and/or processes and/or processing steps that modify and/or generate data and/or convert the data into other data, wherein the data may be represented or be present in particular in the form of physical variables.

The term “processor”, “central signal processing”, “control unit” or “data evaluation means” encompasses processing means in the broadest sense, that is to say for example servers, universal processors, graphics processors, digital signal processors, application-specific integrated circuits (ASICs), programmable logic circuits such as FPGAs, discrete analog or digital circuits and any combinations thereof, including all other processing means known to a person skilled in the art or that will be developed in the future. Processors may in this case consist of one or more devices or apparatuses or units. If a processor consists of multiple devices, these may be designed or configured for the parallel or sequential processing or execution of instructions.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for performing an installation process for an application on a runtime environment during operation of a system, with checking of modifications, to be performed during the installation process, on the runtime environment, comprising:
a) configuring at least one installation protection profile for the runtime environment on a basis of an installation policy provided for a purpose of monitoring the installation process, wherein the at least one installation protection profile defines permitted and/or forbidden modifications on the runtime environment during the installation process and wherein the at least one installation protection profile is configured with an aid of metadata contained in an installation package and/or with an aid of states of the runtime environment and/or of the system,
b) performing an installation process for an installation package, to be installed, of the application, for checking purposes, on a test runtime environment isolated from the runtime environment, with application of the at least one installation protection profile,
c) checking whether the installation process has been performed with the installation protection profile being complied with,
d) performing the installation process for the installation package, to be installed, on the runtime environment when the check result is judged to be positive,
e) otherwise rejecting or aborting the installation process.

2. The method as claimed in claim 1, wherein at least one installation protection profile is configured with an aid of rights of the runtime environment and/or of the system.

3. The method as claimed in claim 1, wherein the test runtime environment is provided on the system in isolation from the runtime environment.

4. The method as claimed in one claim 1, wherein the test runtime environment is provided separately from the system on another system.

5. The method as claimed in claim 1, wherein a performance of the installation process is monitored with an aid of one or more installation control units able to be configured by way of the installation protection profile.

6. The method as claimed in claim 1, wherein a cryptographic attestation of the runtime environment is attached to the check result.

7. The method as claimed in claim 1, wherein the check result is derived from a log, created by the test runtime environment, of modifications performed during the installation process.

8. A system suitable for performing an installation process for an application on a system runtime environment during operation of a system, with checking of modifications, to be performed during the installation process, on the runtime environment, wherein the system is designed to the method of claim 1.

9. A computer program product, comprising a computer readable hardware storage device having computer readable program code stored therein, said program code executable by a processor of a computer system to implement a method as claimed in claim 1 on one or more processors of a system.
